(19) United States
(12) Patent Application Publication
(10) Pub. No.: US 2009/0306419 A1
(43) Pub. Date: Dec. 10, 2009

(54) Method for Degumming Triglyceride Oils

(75) Inventors: K. Ko Myong, Lakeville, MN (US); Kristopher T. Mortenson, Burnsville, MN (US); Harapanahalli S. Muralidhara, Plymouth, MN (US)

Correspondence Address: CARGILL, INCORPORATED, P.O. Box 5624, MINNEAPOLIS, MN, 55440-5624, US

(73) Assignee: CARGILL, INCORPORATED, Wayzata, MN (US)

(21) Appl. No.: 12/224,690

(22) PCT Filed: Feb. 23, 2007
(86) PCT No.: PCT/US2007/004807

§ 371 Date: Nov. 18, 2008

Related U.S. Application Data
(60) Provisional application No. 60/777,832, filed on Mar. 1, 2006.

(51) Int. Cl. C11B 3/00; B01D 17/00

(52) U.S. Cl. 554/190; 554/175; 554/204; 210/257.1; 210/206

(57) ABSTRACT

A system and method of degumming a plant derived oil comprising mixing a feed stream under ultrahigh shear conditions to provide a mixed stream, passing the mixed stream through a retention tank, and separating the mixed stream into an aqueous stream and an oil stream is disclosed. The feed stream comprises water, optional added acid(s), and triglyceride oil, such as a plant derived oil, having a relatively high phosphorous content and may also include metal impurities such as calcium, magnesium and/or iron ions. The process can provide a triglyceride oil stream with a phosphorous content of no more than about 10 to 20 ppm and no more than about 0.5 wt. % free fatty acids. In many instances, the triglyceride oil stream has phosphorous content which is no more than about 3% of the phosphorous content of the feed stream. The process also provides a wet gum stream, which may have an AI of 75 or higher.

### CROSS-REFERENCE TO RELATED PATENT APPLICATIONS

This application is a continuation of International Application No. PCT/US2007/004807 and claims the benefit of U.S. Provisional Application Ser. No. 60/777,832, filed Mar. 1, 2006, which is incorporated by reference herein in its entirety.

### BACKGROUND

Plant derived oils have a wide range of uses as food products, fuels and in other applications. Oils derived from plant products must generally be refined, however, to remove unwanted components to increase the suitability of the oil for a particular use. In many applications, including food products, biodiesel fuels and industrial and commercial products, it is often desirable to obtain a degummed or refined oil having a negligible phospholipids content or below 300 ppm in the degummed or refined oil. During degumming processes, it is also desirable to obtain a wet gum with low oil content (>65 AI, dry basis) in order to improve oil yield. AI is the acetone insoluble fraction representing phospholipid content in the gum. Typical AI value from a conventional water degumming is 60-70. When lecithin or fluid lecithin is a byproduct of the degumming process, it is desirable to separate nearly all the phospholipids from the feed oil into a wet gum phase. A more effective phosphorous removal from the crude feed oil in a degumming process can provide finer refining as well as yield improvement on fluid lecithin or powdered lecithin production.

Previous methods of removing phospholipids have a variety of drawbacks. For example, conventional water degumming ineffectively removes phospholipids as well as mineral impurities, such as calcium, magnesium and iron, constituting non-hydratable phospholipids (NHP) from a crude oils leaving 50-300 ppm phosphorous content in the degummed oil and retains significant oil fraction in a wet gum. The phosphorous content and mineral impurities in the degummed oil largely depend on level of NHP or mineral impurities in the crude oil. In a case of lecithin production, ineffective removal of phospholipids results in low production efficiency. Moreover, although it is generally known that higher centrifuge temperature provides less oil content in the wet gum, improvement on oil yield is rather difficult task for the conventional water degumming due to a sharp increase in the phosphorous content in the degummed oil as the centrifugation temperature increases above 75° C.

Conventional enzymatic degumming may provide 5-15 ppm phospholipids content in a degummed oil and low oil content in a wet gum. However, it may result in an unsatisfactory amount of free fatty acids in the degummed oil due to phospholipids conversion into lyso-phospholipids and free fatty acids. For example, additional free fatty acids may be generated from % conversion of phospholipids in the crude oil. The enzyme employed may be very expensive. Capital requirement for an enzymatic degumming process may also be much higher than the conventional water degumming and other degumming processes. Moreover, the enzymatic process requires higher deodorizer capacity and dilutes the distillate stream.

In another reported process, an oil feed stream is mixed with a blade-type high shear tank mixer (Alfa Laval) with multiple blades. This process may provide a degummed oil with relatively low levels of phosphorous, calcium, magnesium and iron but requires applying 1:9 weight ratio of aqueous citric acid (3% citric acid) to the feed oil stream. This is equivalent to using 10% water and 3333 ppm citric acid (dry basis). In contrast, a conventional water degumming operation of crude soybean oil commonly uses about 2 wt. % water. There are a number of major disadvantages with the method based on the use of a large amount of dilute aqueous citric acid. The 10% water addition may cause a significant amount of additional oil loss compared to the conventional water degumming method. In addition, the removal of water from the wet gum byproduct stream can entail an extremely high evaporation cost and energy input requirement. Recycling of acid water requires additional separation equipment for the degumming operation. The amount and cost of acid per metric ton of crude oil processed is also extremely high. Moreover, the phosphorous content and mineral impurities in the degummed oil may not be sufficiently low for effective bleaching operation. The higher metal content can require higher bleaching clay load and result in higher oil loss and operational cost.

Accordingly, there is a continuing need for alternative refining methods, which can provide cost-effective removal of phosphorous, preferably to levels of 5 ppm to 10 ppm or below, depending on applications, and of metallic impurities (such as calcium, magnesium and/or iron) and significant reduction in oil loss into the wet gum phase having greater than 75 AI. The (below 5-10 ppm) (e.g., via a conventional deodorization operation) of phosphorous content in the degummed oil can enable physical stripping of the free fatty acid and eliminate the need for alkaline refining. Elimination of alkaline refining may provide significant reduction of waste-water, capital saving, chemical saving, and further reduction of oil loss. Even without alkaline refining, low levels of metallic impurities in the degummed oil may result in no load increase in the bleaching operation. In a case of production of a fluid lecithin or powdered lecithin, a more efficient process may also provide a significant improvement in yield.

### SUMMARY

The present application relates to processes for degumming triglyceride oils, such as plant derived oils. The methods described herein make use of ultrahigh shear mixing operations to achieve effective degumming of triglyceride oils. Some embodiments relate to a method of degumming a triglyceride oil, such as a crude vegetable oil, which includes mixing a crude oil feed stream containing a relatively low level of water and, optionally added acid(s), under ultrahigh shear conditions to provide a mixed stream. Inline ultra high shear mixers are particularly advantageous for use in the present process. The use of an inline ultra high shear mixer can ensure that all of the feed stream is subjected to intense mixing under ultrahigh shear conditions. The mixed stream is then typically passed through a retention tank, and subsequently separated into a wet gum stream (also referred to herein as an “aqueous stream”) and an oil stream. Passing the mixed stream through the retention tank can allow submicron size droplets of the aqueous phase to agglomerate into larger droplets. After the ultrahigh shear mixing operation, the mixed stream may be passed through a retention tank under conditions that will not subject the aggregated droplets to substantial shear forces, e.g., break-down of larger aggregates into smaller droplets causing finer dispersion and less effective centrifuge separation. To achieve this, the mixed stream is desirably not subjected to any dynamic or vertical mixing while in the retention tank. It may be desirable to pass the mixed stream through a series of two or more retention tank to more effectively aggregate the aqueous phase and/or to eliminate the vertical mixing of the mixed stream.

The feed stream commonly includes a plant derived oil having a phosphorous content of at least 200 ppm total phosphorous, more commonly at least 300 ppm and often 500 ppm total phosphorous or higher. Crude vegetable oils having phosphorous contents in of about 500-1000 ppm may be are quite effectively refined using the present process. It is often desirable to produce a product oil stream having a phosphorous content which is no more than about 3% of the phosphorous content of the feed stream, typically no more than about 10 ppm and, more desirably no more than about 5 ppm total phosphorus. The oil stream which is produced after the separation operation commonly has a relatively low level of free fatty acids (FFA), e.g. no more than about 0.5 wt. % free fatty acids and, more desirably, no more than about 0.3 wt. % free fatty acids, in order to lessen the need for additional downstream processing of the refined oil. It is often desirable to produce a product oil stream having a total metal content which is no more than about 10 ppm, preferably 5 ppm or less, e.g., product oils streams containing no more than about 5 ppm of calcium, no more than 5 ppm of magnesium and no more than 0.05 ppm of iron. The present process may also provide a wet gum byproduct with 75 AI or higher (e.g., with on AI of 75-85). It is also often desirable to produce the degummed oil with somewhat lower free fatty acid content and chlorophyll content than the crude oil. The reduction on free fatty acid and chlorophyll can lessen the need for additional downstream processing of the refined oil.

A system for degumming a triglyceride oil, such as a plant-derived oil (e.g., a crude vegetable oil), is also described herein. The system commonly includes an oil feed stream line in fluid connection with an ultrahigh shear mixer, at least one retention tank in downstream fluid connection with the ultrahigh shear mixer, and an oil/aqueous phase separation device in downstream fluid connection with the retention tank(s). For example, the system may include one or more additional retention tanks interposed in fluid connection between the primary retention tank and the oil/aqueous phase separation device. The effectiveness of the present process is such that the system generally/desirably does not require the inclusion of an alkaline refining unit or a predeodorization. Commonly, however, the system may include a deodorization unit and/or bleaching unit in downstream fluid connection with the oil/aqueous phase separation device. The system may optionally include one or more inline static mixers in upstream fluid connection with the ultrahigh shear mixer. The ultrahigh shear mixer is desirably an inline ultrahigh shear mixer. The system may also optionally include one or more temperature control units, e.g., one or more heat exchangers to maintain the process stream(s) within a desired temperature range.

Other embodiments of the present process relate to a method of degumming a triglyceride oil, which includes adding chelating acid and/or salt thereof and water to the triglyceride oil to provide a feed stream. The stream containing the triglyceride oil and chelating acid/salt may have a phospholipid content of about 10,000 ppm or higher (or a total phosphorus content of at least about 200 ppm and, often, at least about 500 ppm). The feed stream may be mixed under ultrahigh shear conditions to provide a mixed stream having an aqueous component with a pH of about 4 to 6.5. The ultrahigh shear mixing can effectively promote action of acid and/or water several-fold by creating submicron size aqueous droplets and by providing extremely fast direct contacts among reactants. The water is added to hydrate hydratable phospholipids. Acid, such as citric and/or phosphoric acid, may added to chelate non-hydratable phosphatides (“NHP”). The amount of acid required is determined by level of NHP in the crude oil. The amount of water required is generally determined by level of phospholipids and acid concentration. The mixed stream may be passed through a retention tank to provide an agglomerated stream which may be separated to provide an oil stream and wet gum stream. For certain product applications, the oil stream produced by the separation operation desirably includes no more than about 300 ppm phospholipids (phosphorus content of no more than about 10 ppm) and no more than about 0.3 wt. % free fatty acids. The wet gum stream can have a relatively high AI, e.g., an AI of 75 or higher.

### BRIEF DESCRIPTION OF THE DRAWINGS

FIG. 1 is a schematic drawing of one embodiment of a system for a continuous ultrahigh shear oil degumming process.

FIG. 2 is a schematic drawing of one embodiment of an inline continuous ultrahigh shear oil mixer.

FIG. 3 is schematic drawing of another embodiment of a system for a continuous ultrahigh shear oil degumming process.

FIG. 4 is schematic drawing of another embodiment of a system for a continuous ultrahigh shear oil degumming process, which includes a retention tank for holding a mixed oil stream prior to separation.

FIG. 5 is schematic drawing of another embodiment of a system for a continuous ultrahigh shear oil degumming process, which includes structures for holding the mixed oil stream in a retention tank prior to separation and for recycling a portion of the mixed oil stream into the feed oil stream.

FIG. 6 is a schematic drawing of another embodiment of a system for a continuous ultrahigh shear oil degumming process, which includes a subsystem for enzymatic treatment of the wet gum stream with recycling of recovered oil into the feed oil stream.

FIG. 7 is a schematic drawing illustrating another example of a system for a continuous ultrahigh shear oil degumming process, which includes a chelation tank upstream from the ultrahigh shear inline mixer.

FIG. 8 is a schematic drawing illustrating another example of a system for a continuous ultrahigh shear oil degumming process.

FIG. 10 is a schematic drawing illustrating results of a continuous high shear oil degumming process.

FIG. 11 is a schematic drawing illustrating another example of a system for a continuous ultrahigh shear oil degumming process.

COMPARISON FIG. A is a schematic drawing illustrating one example of a conventional continuous water degumming process.

COMPARISON FIG. B is a schematic drawing illustrating one example of a continuous enzymatic degumming process.

### DETAILED DESCRIPTION

The Figures illustrate various embodiments of the present process for degumming triglyceride oils, such as plant derived oils. Suitable triglyceride oils, which may be degummed using the methods disclosed herein include crude vegetable oils (e.g., crude soybean oils) and other plant-based oils, such as soybean oils which have been subjected to prior refining and/or fractionating operations, and/or similar oils derived from other vegetable sources, such as canola oil, corn oil, sunflower seed oil, cottonseed oil, rapeseed oil, safflower oil, sesame seed oil, peanut oil, palm oil, palm kernel oil, coconut oil, rice bran oil, mustard seed oil, and/or castor oil. The methods described herein typically involve mixing a feed stream which includes water (e.g., about 1 to 5 wt. %) and a phosphorus-containing triglyceride oil in an ultra high shear mixing operation to provide a mixed oil stream, which includes a relatively small amount of a highly dispersed aqueous phase. Inline ultra high shear mixers are particularly suitable for conducting the ultra high shear mixing operation.

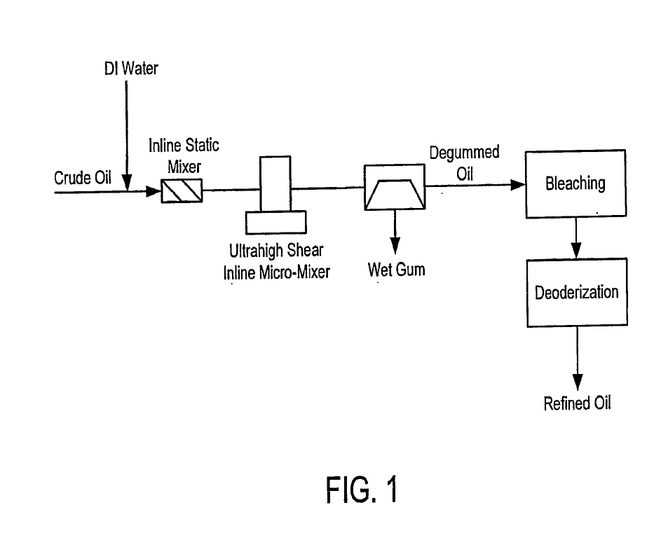

Referring to FIG. 1, water is added to an oil stream to form a feed stream. The oil is generally a plant-based oil, which may have a phosphorus content of 200 ppm or higher. The process is notable because it may be used to remove a very high percentage of the phospholipids from oils having a phospholipid content of about 10,000 ppm or even higher. The feed stream may comprise about 1 wt. % to 5 wt. % water, often after the addition of water to achieve a desired level. Commonly, the feed stream is passed through an inline static mixer to uniformly blend water/acid with the oil phase prior to the ultrahigh shear mixing operation. The feed stream is passed through an ultra high shear mixer to provide a mixed stream. One suitable ultrahigh shear mixer is a rotor-stator type ultrahigh shear mixer. As noted above, inline ultrahigh shear mixers, such as inline rotor-stator type ultrahigh shear mixers, are particularly suitable for use in the present degumming method. As shown in FIG. 1, where the system is designed to treat relatively large volumes of phosphatide-containing oil, it may be advantageous to employ an in-line rotor-stator type ultra high shear mixer. One suitable example of such a mixer is the DISPAX REACTOR, an in-line ultra high shear micro-mixer available from IKA Works Inc., employing a rotor-stator design. The capacity of commercially available inline ultrahigh shear mixers such as the DISPAX reactor typically ranges from about 5 to 1,750 kg/min. The performance characteristics of an IKA DISPAX ultra high shear mixer with three stage rotor-stator generators is compared in Table 1 to the performance parameters for a conventional multiple blade shear mixer (available from ALFA LAVAL) and a stirred tank mixing device.

TABLE 1
Comparison of Performance Characteristics of Commercial Mixers

| | IKA Mixer | | Alfa Laval Mixer | | Tank Mixer | |
|---|---|---|---|---|---|---|
| | Ultra High Shear | | High Shear | | Relatively Low Shear | |
| Type | Inline rotor-stator | | Multiple blade | | Tank mixer | |
| | shear mixer | | tank shear mixer | | | |
| Flow rate | Not limited | | Limited | | Not limited | |
| Power | 60 HP/100 gpm | | 30 HP/100 gpm | | 1-3 HP/100 gpm | |
| Shear efficiency | Near 100% | | Some loss | | Nearly all loss | |
| | | | through circulation | | through circulation | |
| Residence time | 0.1-0.3 | sec. | 5-30 | sec. | 30-60 | min |
| Micro-mixing efficiency | Nearly 100% | | <100% | | ~0% | |
| Shear rate (sec⁻¹) | 11500 | | 1400 | | 15 | |
| Shear freq. (sec⁻¹) | 4,800,000 | | 900 | | 60 | |
| Shear number (sec⁻²) | 55.2 | billion | 1.26 | million | 900 | |
| Droplet size | <0.5-1 | μm | 1-5 | μm | ~20 | μm |

| | | | |
|---|---|---|---|
| Surface area ratio | 40 | 4 | 1 |

For the IKA mixer, the shear rate is the tip velocity of the rotor divided by the distance between the rotor and stator. The shear frequency is the product of the number of teeth in the rotor, the number of teeth in the stator, and the rotational speed of the rotor (measured in revolutions per second). The shear number is the product of the shear rate and the shear frequency.

After the ultrahigh shear mixing operation, the mixed stream may then be separated into an oil phase comprising a degummed oil and an aqueous phase comprising a wet gum, by use of a continuous centrifuge. The degummed oil may be the final product of the process. Alternatively, the degummed oil may be bleached and/or deodorized to yield a refined oil. If desired, the wet gum may be dewatered to produce a dry gum or fluid lecithin or may be dewatered and deoiled to produce a powder lecithin.

In some embodiments, the mixing operation may comprise subjecting the feed stream to ultrahigh shear conditions having a shear frequency of at least about 100,000 sec⁻¹. In some embodiments, the shear frequency may be about 1,000,000 to 10,000,000 sec⁻¹. In some embodiments, the mixing operation may comprise subjecting the feed stream to ultrahigh shear conditions having a shear rate of at least about 5,000 sec⁻¹. In some of these embodiments, the shear rate may be at least about 8,000 sec⁻¹ and, often may be about 10,000 to 15,000 sec⁻¹. The ultrahigh shear mixing operation may also be characterized in terms of a shear number. The mixing operation may comprise subjecting the feed stream to ultrahigh shear conditions having a shear number of at least about 100,000,000 sec⁻² (10⁸ sec⁻²). The ultrahigh shear mixing conditions may have a shear number of at least about 10⁹ sec⁻², and shear numbers of about 10¹⁰ to 10¹¹ sec⁻² are quite common. In typical embodiments, the feed stream has a residence time in the ultrahigh shear mixer for no more than about 1.0 second and residence times of about 0.05 to 0.5 second, often about 0.1 to 0.3 second, are quite common. The feed stream is typically maintained at a temperature of about 40° C. to 90° C. and, more desirably, about 60° C. to 80° C. during the ultrahigh shear mixing operation. In many embodiments, the separating operation may be carried out with the mixed stream at a temperature of about 60° C. to 95° C.

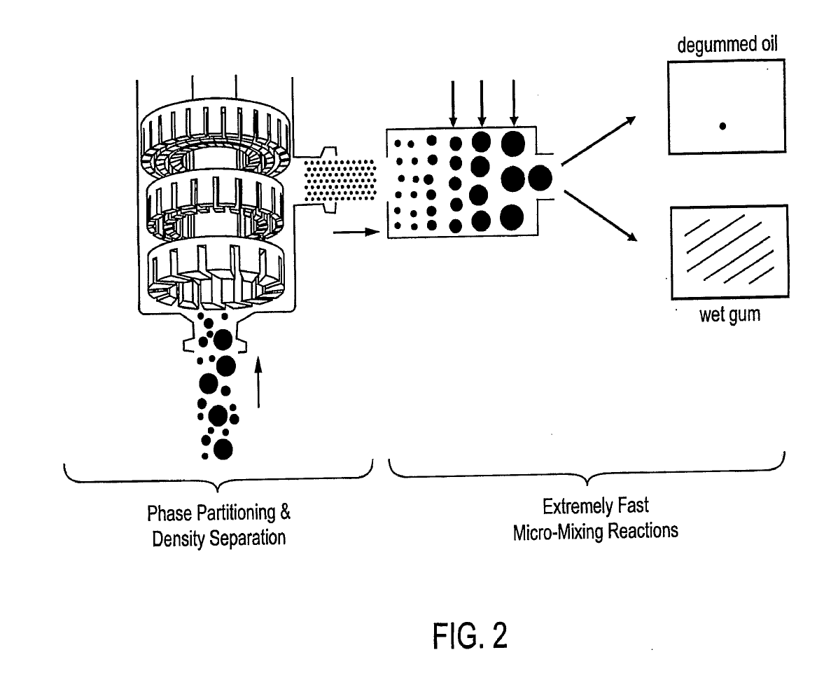

Referring to FIG. 2, a feed stream enters the rotor-stator type inline ultra high shear mixer through an inlet. The ultra high shear mixer is shown as a three stage ultra high shear mixer employing progressively finer rotor and stator teeth. The ultrahigh shear inline micro-mixer may be equipped with one to three rotor-stator generators with choice of ultrafine, fine, medium and/or coarse grade teeth. The ultra high shear inline micro-mixer shown in FIG. 2 is a three-stage ultra high shear mixer employing progressively finer rotor and stator teeth. The mixed feed stream flows out of an outlet of the ultrahigh shear inline micro-mixer which is commonly in downstream fluid connection with a retention tank.

Acid, such as citric and/or phosphoric acid, may be injected into crude oil stream upstream from the ultrahigh shear mixer and the resulting stream may be pre-blended using an inline static mixer. In some instances, the NHP in the process stream may be more effectively hydrated by holding the process stream with the added acid in a chelation tank prior to water addition, blending through an inline static mixer prior to the ultrahigh shear mixing operation. Alternatively, dilute aqueous acid solution may be injected and blended into the feed stream using an inline static mixer prior to the ultrahigh shear mixing operation.

The mixed process stream flows from an outlet of the ultra high shear mixer, which is commonly in downstream fluid connection with a retention tank. The tank may be configured to provide an effective residence time such that the contents of the mixed stream, in particular the highly dispersed aqueous phase, at least partially agglomerate. Additional tank inlets may be used for the introduction of a caustic agent, additional water, or acid. The tank outlet stream may be separated, e.g., by centrifugation, decantation, and/or other suitable separation technique(s), to provide a degummed oil stream and a wet gum stream.

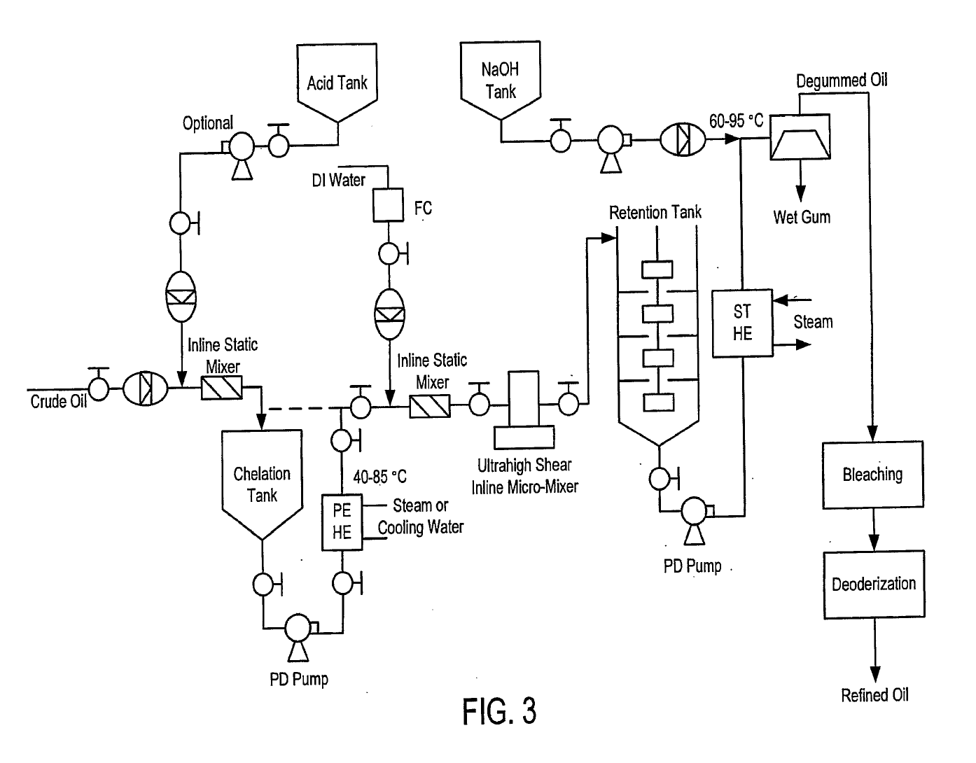

Referring to FIG. 3, water may be added to an oil stream to form a feed stream. The “wet” feed stream is passed through an ultra high shear mixer to provide a mixed stream. In some embodiments, a chelation tank may be employed to mix acids where water is added after the chelation step but prior to an inline static mixer located before the ultrahigh shear inline micro-mixer. In other embodiments, diluted acids or water alone may be added prior to the inline static mixer before the ultrahigh shear inline micro-mixer. The inline static mixer is used to facilitate uniformly blending the crude oil and water, diluted acids and/or water/acids prior to the ultrahigh shear mixing operation. The “wet” feed stream is then passed through an ultrahigh shear inline micro-mixer to provide a mixed stream.

The mixed stream is typically fed from the ultrahigh shear mixer to a downstream retention tank where the submicron size aqueous droplets may begin to agglomerate. The contents of the retention tank may be slowly agitated (under relatively low shear conditions) to promote agglomeration; to prevent undesired breakup of agglomerated droplets into smaller droplets; and to minimize fine-dispersion of broken aqueous droplets. Some retention tanks may include compartment dividers between mixing blades that can aid in the prevention of vertical mixing of the contents within the tank. In some embodiments, the mixed stream is fed to the retention tank through an inlet near the top of the agglomeration tank, and the mixed oil is drawn from an outlet near the bottom of the agglomeration tank. Alternatively, other inlet/outlet configurations may be used. Alternatively, the retention tank may be substantially free of agitation. Some retention tanks may include baffles that may prevent back mixing of the contents of the retention tank.

The mixed oil and water may then be separated into a degummed oil phase and an aqueous phase comprising a wet gum (“wet gum phase” or “wet gum stream”), by use of a continuous centrifuge, decanter, or other suitable separator. The degummed oil may be the final product of the process. Alternatively, the degummed oil may be further refined, e.g., via bleaching and/or deodorizing to yield a refined oil. When desired, the wet gum stream may be dewatered to produce a dry gum or fluid lecithin or may be dewatered and deoiled to produce a powder lecithin.

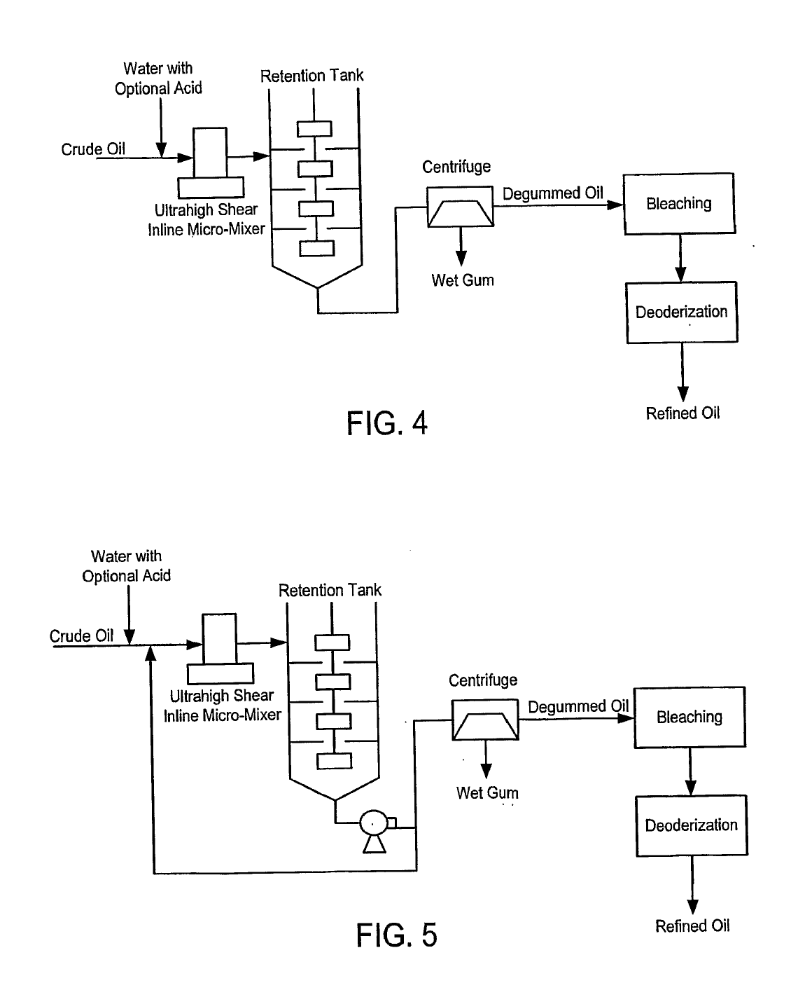

FIG. 4 shows a schematic representation of one embodiment of the present degumming system, which includes a retention tank in downstream connection with the ultrahigh shear mixer, as well as downstream bleaching and deodorizing units. FIG. 5, shows a variation of the system of FIG. 4. According to some embodiments, a portion of the mixed oil and water drawn from the retention tank, is recycled and added to the feed stream entering the ultra high shear mixer. Recycling a portion of the mixed oil and water stream may increase the over all efficiency of the degumming process.

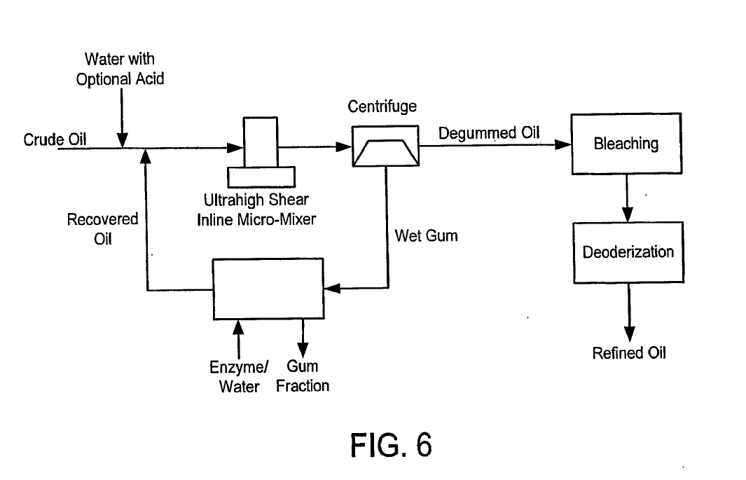

FIG. 6, shows a variation of the system of FIG. 1. According to some embodiments, the aqueous phase comprising wet gum (“wet gum stream”) may be further refined using a conventional enzymatic degumming operation. In this operation, the wet gum may be treated with phospholipase enzyme. The wet gum is then separated to provide a recovered oil stream and a gum fraction. The recovered oil may then be used as a final product, added to the degummed oil stream, or, as shown in FIG. 4, recycled and added to the feed stream entering the ultra high shear mixer.

Referring to FIG. 4, an aqueous acid solution may be added to an oil stream to form a feed stream. Alternatively, an aqueous basic stream may also be added to the feed stream. The feed stream is passed through an ultra high shear mixer to provide a mixed stream. The mixed stream may then be separated into an oil phase comprising a degummed oil and an aqueous phase comprising a wet gum, by use of a continuous centrifuge. The degummed oil may be the final product of the process. Alternatively, the degummed oil may be bleached and/or deodorized to yield a refined oil.

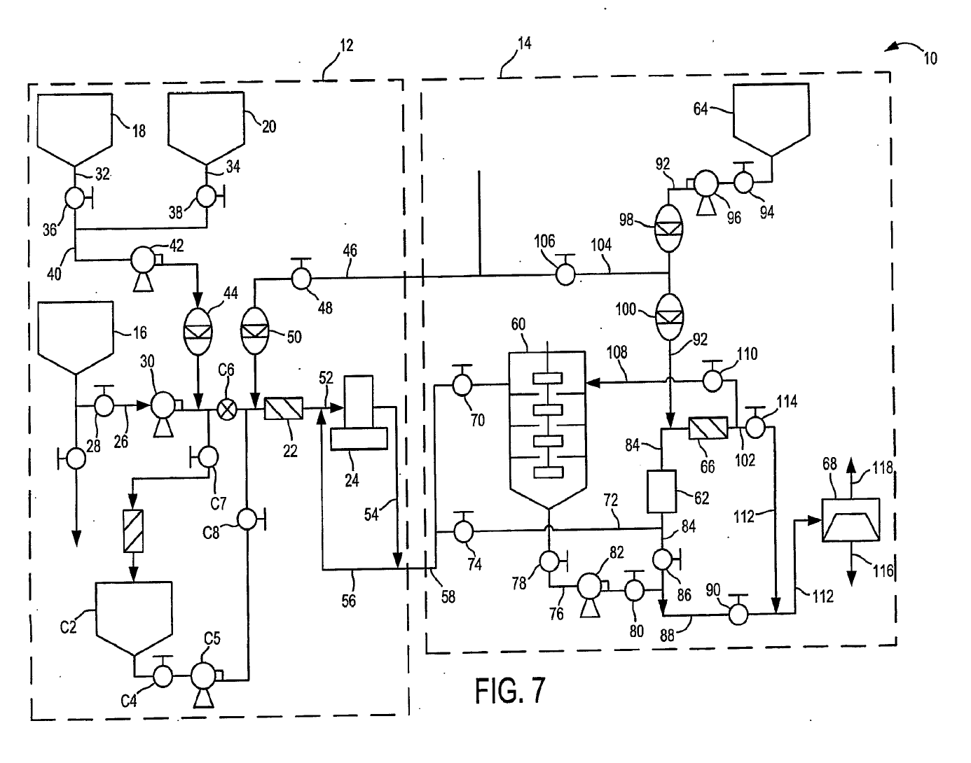

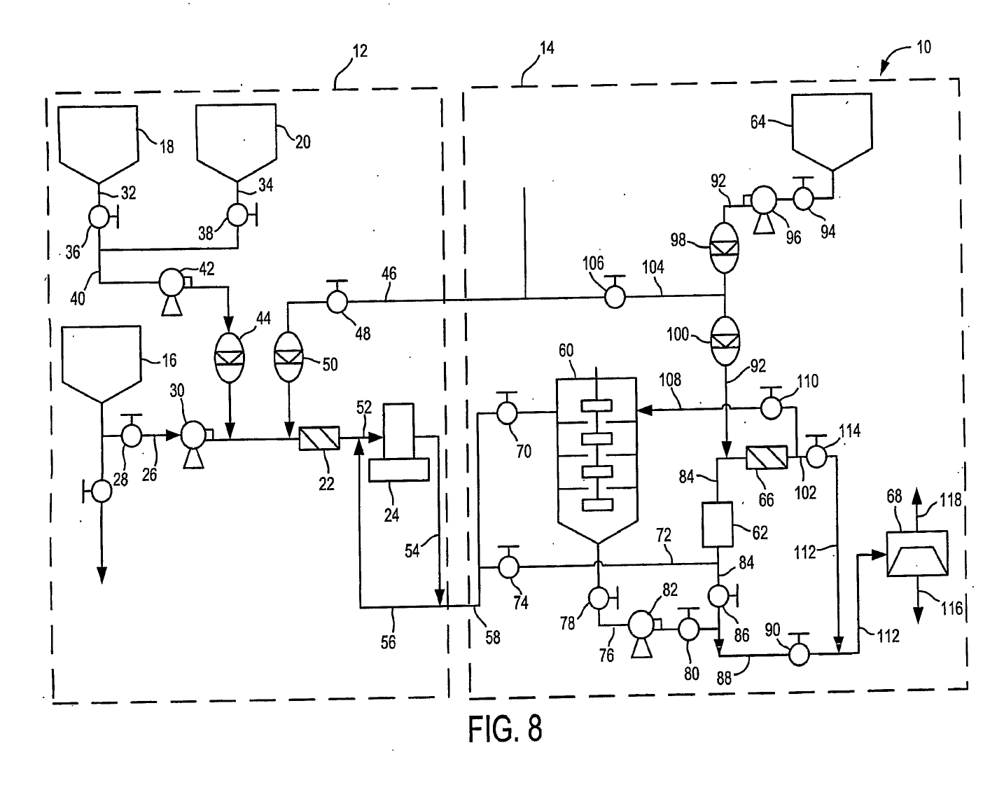

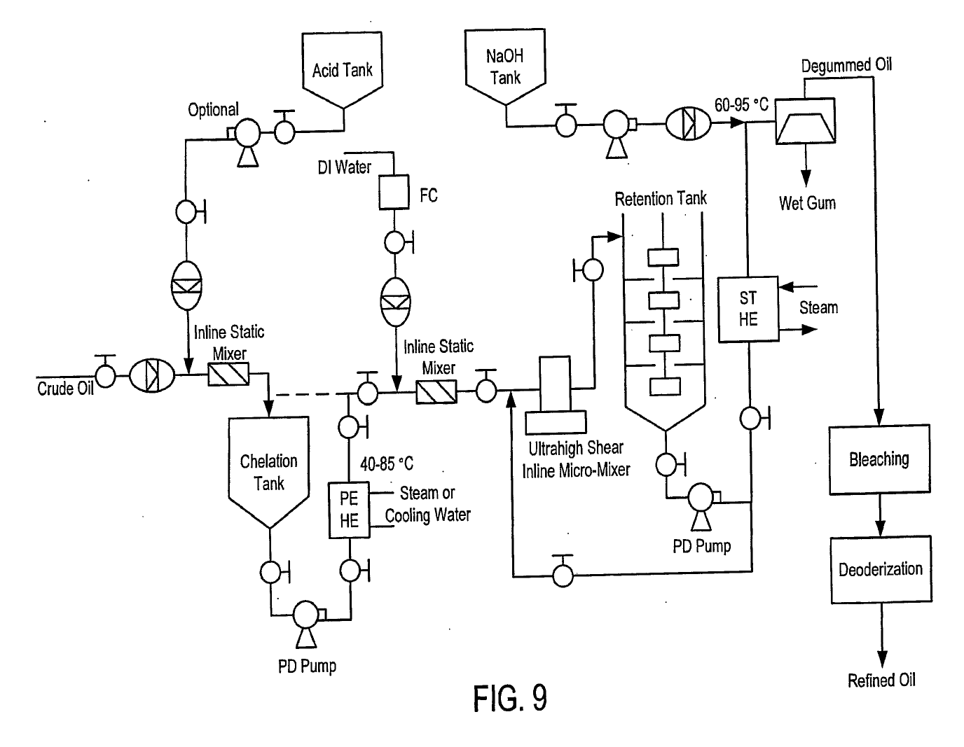

Referring to FIG. 7, an aqueous solution of acid and/or base may be added to a oil stream comprising triacylglycerols (“TAG”), phospholipids (“PLS”) and free fatty acids (“FFA”) to provide a feed stream. The aqueous acid and or base may be added separately or in a single, pre-mixed stream. The feed stream is mixed under ultra high shear conditions to provide a mixed stream. The mixed stream may be fed to a retention tank where the oil and water phases may begin to agglomerate. The retention tank may be agitated to prevent undesired separation of the oil and aqueous phases. The mixed oil and water is draw from the retention tank. A portion of the mixed oil and water drawn from the retention tank, may be recycled and added to the feed stream entering the ultra high shear mixer. The remainder of the mixed oil and water may be separated into an oil phase comprising a degummed oil and an aqueous phase comprising a wet gum, by use of a continuous centrifuge. The degummed oil may be the final product of the process. Alternatively, the degummed oil may be bleached and/or deodorized to yield a refined oil.

Referring to FIG. 7, an exemplary embodiment of an ultrahigh shear oil degumming process may be carried out by a system 10 including a mixing subsystem 12, and a separation subsystem 14. Mixing subsystem 12 may include an oil reservoir 16, a first acid tank 18, a second acid tank 20, an inline static mixer 22, a chelation tank C2 and an ultrahigh shear inline micro-mixer 24. Oil stream 26 provides crude oil from crude oil reservoir 16 to the degumming process. The flow of oil stream 26 may be controlled by valve 28 and positive displacement metering pump 30. First acid tank 18 provides a first acid stream 32 that is controlled by valve 36. Second acid stream 20 provides a second acid stream 34 that is controlled by valve 38. Acid streams 32 and 34 may be combined to stream 40 which may include only a first acid, only a second acid, or a mixture of acids. For example, first acid tank 18 may be used to supply a solution of phosphoric acid, while second acid tank 20 may be used to supply a solution of citric acid. Alternatively, different acids or combinations of acids may be used. In some alternative embodiments, more than two acid tanks and streams may be used to provide a variety of acids to the degumming process. Stream 40 passes through pump 42 and check valve 44 and is added to crude oil stream 26. The valve C7 allows acids and crude oil stream 26-1 to pass through inline static mixer C1 and flow into chelation tank C2. Valves C4 and C8 and pump C5 allow chelated oil stream 26-4 to pass through inline static mixer 22. The valve C6 allows acids and crude oil stream 26-2 to pass through inline static mixer 22 and to flow through ultrahigh shear inline micro-mixer 24. Inline static mixers C1 provides uniform blending of acids and crude oil stream 26-3. In typical embodiments, the uniformly blended oil stream 26-3 may be mixed in chelation tank C2 to chelate NHPs with a residence time about 5 to 60 minute and residence times of about 15 to 45 minute, often about 25 to 35 minute, are quite common. In other embodiments, the uniformly blended oil stream 26-2 may be directly flow through inline static mixers 22, which provides uniform blending of acids and crude oil stream 26-2.

Deionized water may be provided by stream 46 which in turn may be controlled by valve 48, and check valve 50. Stream 46 may be added to the oil stream 26 either upstream or downstream of the point where stream 40 is added to oil stream 26. Alternatively, stream 46 may be added to stream 40 before stream 40 is added to oil stream 26. Oil stream 26, stream 40 and stream 46 may be combined to provide feed stream 52. Feed stream 52 may pass through an inline static mixer 22 to uniformly pre-mix feed stream 52 before feed stream 52 enters ultra high shear mixer 24.

Feed stream 52 may pass through ultra high shear mixer 24 to provide a stream 54. Stream 54 may then be split to provide a recycle stream 56 and a mixed stream 58. In some embodiments, feed stream 52 may be subjected to ultra high shear conditions with in ultra high shear mixer 24 wherein the shear number is at least about 10⁸ sec⁻². In some embodiments, the shear number may be at least about 10¹⁰ sec⁻².

Separation subsystem 14 may include a retention tank 60, a heat exchanger 62, a caustic tank 64, an online static mixer 66, and a separator 68. Mixed stream 58 may pass through valve 70, and into retention tank 60. Retention tank 60 may be any suitable tank. According to some embodiments, retention tank 60 may be a cylindrical tank having a height to diameter ratio of 4:1. In some embodiments, retention tank 60 may have an inlet near the top of the tank, and an outlet from a point near the bottom. Alternatively, other sizes or types of retention tanks having different inlet/outlet configurations may be used. In some embodiments, retention tank 60 may include internal baffles to prevent back mixing of the contents of the retention tank. In some embodiments, retention tank 60 may include a mechanical stirrer, with one or more mixing blades, to prevent unwanted separation of the oil and aqueous phases. In some embodiments, the agglomeration tank 60 may include one or more internal compartment dividers between mixing blades to prevent vertical mixing of the contents of the agglomeration tank. According to some embodiments, the effective residence time within the retention tank may be at least about 10 minutes. In some exemplary embodiments, the effective residence time in the retention tank may be at least about 30 minutes. In yet other embodiments, the retention time in the retention tank may be at least about 45 minutes or longer. The amount of residence time in the retention tank depends on the flocculation or dispersion condition of the aqueous droplets. Finer dispersions require longer residence time in the retention tank. In some alternative embodiments, mixed stream 58 may partially or completely bypass retention tank 60. For example, valve 70 may be closed and mixed stream 58 may be directed through bypass line 72 and valve 74.

Agglomerated stream 76 may exit retention tank 60 and be regulated by valves 78 and 80, and pump 82. Agglomerated stream 76, or alternatively bypass stream 72, may be passed through line 84 and valve 86. The temperature of the contents of line 84 may be controlled by heat exchanger 62. Heat exchanger 62 which may be a tube in shell heat exchanger, or alternatively, another suitable type of heat exchanger which provides low shear breakup of agglomerated droplets. The temperature of the contents of line 84 may be between about 60° C. and 90° C. The contents of stream 84 may be passed through mixer 66. Mixer 66 may be an inline static mixer or other mixer suitable to uniformly blend the contents of stream 84 prior to separation. Alternatively, agglomerated stream 76 or alternatively bypass stream 72 may pass through bypass stream 88 which may, in turn be controlled by valve 90. bypass stream 88 may bypass heat exchanger 62 and mixer 66. In an alternative embodiment, a bypass may be provided such that heat exchanger 62, mixer 66, or both may be bypassed.

Caustic tank 64 my supply stream 92 with a caustic agent. Stream 92 may be controlled by valve 94 and pump 96. Optionally, check valves 98 and 100 may also be used to prevent backflow in stream 92. Stream 92 may be combined with the contents of line 84 to at least partially neutralize the contents of line 84 and yield stream 102. In some embodiments, stream 104 may comprise water that may be added to stream 92. Stream 104 may be controlled by valve 106. Alternatively, the addition of the caustic agent to the contents of line 84 may be omitted.

A portion of stream 102 may be drawn off and recycled to retention tank 60 via stream 108. The flow of stream 108 may be controlled by valve 110. Recycling a portion of stream 102 may increase the overall efficiency of the degumming process. The portion of stream 102 that is not recycled may pass through line 112 be regulated by valve 114. In some embodiments, the contents of line 112 may be passed through a second retention tank. The second retention tank may be configured such that the contents of line 112 has an effective residence time in the second retention tank of about 1 to about 25 minutes. In some exemplary embodiments, the effective residence time in the second retention tank may be about 5 to 10 minutes. The ratio of the volume of the first retention tank to the volume of the second retention tank may be from about 50:1 to 2:1. In some exemplary embodiments, the volume ratio of the first retention tank to the second retention tank may be from about 2:1 to 5:1.

The contents of line 112 may be separated by separator 68. Separator may be a centrifuge or other suitable separator. Separator 68 may generate a bottoms byproduct stream 116 and a product stream 118. The bottom stream 116 may comprise a gum fraction including water and a phospholipid component. Product stream 118 may comprise a degummed oil that may be a final product, or used as an input to further processes.

Referring to FIG. 7, a system for ultra high shear degumming processes generally includes a Process Hydration tank (also referred to as a “chelation tank”) for holding a oil for processing. The oil may be pressed and extracted soy bean oil. Alternatively, the Process Hydration Tank may hold a mixture of oil, acid, and/or water. The contents of the Process Hydration tank may be heated or cooled to an appropriate process temperature and mixed in one or more ultra high shear mixers. In some embodiments, the contents of the Process Hydration Tank may be at a temperature of about 45° C. to 60° C. In an exemplary embodiment, the oil mixture may be at a temperature of up to about 80° C. In some embodiments the water and/or acid may be added to the oil just prior to entering the ultra high shear mixer. It may be advantageous to subject the resulting feed stream to a premixing step, e.g. with a static mixer and/or a stirred tank mixer, prior to the ultra high shear mixing operation.

After the ultra high shear mixing operation, the mixed oil stream may be fed to a Retention Tank. In some embodiments, the Retention Tank may include an optional active stirrer (e.g., multi-blade stirrer) and/or baffles. The Retention Tank may be selected to provide a residence time of about 10 to 120 minutes. In some of these embodiments, the Retention Tank may be selected to provide a residence time of about 45 to 75 minutes. In an exemplary embodiment the Retention Tank may have a height to diameter ratio of about 2:1 to 6:1, e.g., and retention tanks with a height to diameter ratio of about 4:1 are quite commonly employed.

An optional secondary Retention Tank may also be used in series with the primary retention tank. The primary retention tank may have a height to diameter ratio of about 2:1 to 6:1, e.g., a retention tank with a height to diameter ratio of about 4:1 may be employed. In some embodiments, the Secondary Retention Tank may be selected to provide an effective residence time of about 2 to about 50 minutes. In an exemplary embodiment, the Secondary Retention Tank may be selected to provide an effective residence time of about of about 5 to 25 minutes, or of about 5 to 10 minutes. The mixed oil stream may be separated, e.g., by a centrifuge, to yield a degummed oil and an aqueous (“wet gum”) stream. The oil mixture may then be heated or cooled to a desired temperature prior to separation. In some embodiments, the temperature of the oil mixture may be controlled to between about 50° C. to 90° C. and temperatures of about 70 to 85° C. may be particularly advantageous to facilitate separation of the oil and wet gum phases.

In some embodiments, a caustic agent, such as NaOH, may be added to the oil mixture prior to centrifugation to neutralize the acids in the mixture. In other embodiments, centrifugation may be done without the addition of a caustic agent. The system of FIG. 9 may be configured in a variety of ways by use of valves and pumps. For example, one or both of the ultra high shear mixers shown may be used. The mixed oil stream may bypass the retention Tank or various other operational units.

Referring to FIG. 3, a system for the ultra high shear degumming of plant derived oil may include an Acid tank for providing an acid to be combined with oil. In some embodiments, water may also be added to the oil stream. The oil may be heated or cooled to a desired temperature either before or after the addition of the acid and/or water. In some embodiments, the oil may be at a temperature of about 30° C. to 60° C. The oil/acid mixture may be pre-mixed in a static mixer and then passed through an ultra high shear mixer to provide a mixed oil stream.

After the ultra high shear mixing, the oil mixture may be fed to an Retention Tank. In some embodiments, the Retention Tank may include an optional active stirrer and/or baffles. The Retention Tank may be selected to provide a residence time of about 30 to 120 minutes. In some of these embodiments, the Retention Tank may be selected to provide a residence time of about 45 to 75 minutes. In an exemplary embodiment the Agglomeration Tank may have a height to diameter ration of about 4:1.

An optional secondary Retention Tank may also be used in series with the primary retention tank. The primary Retention Tank may have a height to diameter ration of about 4:1. In some embodiments, the primary Retention Tank may be selected to provide an effective residence time of about 5 to about 30 minutes. In an exemplary embodiment, the Retention Tank may be selected to provide an effective residence time of about of about 10 to 25 minutes. The oil mixture may them be heated or cooled to a desired temperature prior to centrifugation. In some embodiments the temperature may be between about 50° C. to 90° C. The mixed oil stream may be separated by a centrifuge to yield a degummed oil and a Gum.

In an exemplary embodiment of the present method, a feed stream including 900 metric tons of crude oil (having a composition of 883.35 tons of triacylglycerides, 3.14 tons of free fatty acid (FFA) and 13.5 tons of phospholipids (Pls)) is fed to an ultra high shear acid degumming process (HSAD) and mixed with 0.72 tons of a 50 wt. % citric acid solution and 0.36 tons of a 75 wt. % phosphoric acid solution per day. The ultra high shear acid degumming process yields 882.18 tons of degummed oil (including 878.76 tons triacylglycerides, 3.15 tons free fatty acid, and 0.27 tons phospholipids) and 18.36 tons per day of wet gum (having a composition of 4.59 tons triacylglycerides, 13.23 tons phospholipids, and 0.54 tons salt).

The degummed oil may be fed to a bleaching operation to remove free fatty acid and the remaining phospholipids from the degummed oil. For example, the degummed oil is bleached with 7.5 tons of bleaching clay (0.85% of the degummed oil). The bleaching operation may yield 878.97 tons per day of bleached oil including 875.82 tons of triacylglycerides and 3.14 tons of free fatty acid. The bleaching process also yields 11.97 tons of spent clay per day including 2.94 tons of triacylglycerides, 7.5 tons of bleaching clay and 0.27 tons of phospholipids. The overall process results in a loss of 7.53 metric tons per day of triacylglycerides.

Referring to Comparison FIG. A, a conventional water degumming process may include water degumming, alkaline refining, bleaching, and deodorization operations. An oil feed comprising triacylglycerols (“TAG”), phospholipids (“PLS”) and free fatty acids (“FFA”) water, and impurities (“IP”) is subjected to a conventional water degumming operation. The resulting degummed oil stream is then subjected to alkaline refining to provide a soap stock including TAG, Soap, PL S and water, and a once refined oil including TAG, impurities, FFA, and water. The once refined oil may then be subjected to clay bleaching to yield a bleached oil. The bleached oil then may be deodorized to remove FFA and impurities to provide a fully refined oil.

Referring to Comparison FIG. B, a conventional enzymatic degumming process may include an enzymatic degumming operation, and optionally, a bleaching operation, a pre-deodorization operation, a deodorization operation, and/or an enzyme recovery and recycle operation.

### EXAMPLES

The following examples are presented to illustrate the present invention and to assist one of ordinary skill in making and using the same. The examples are not intended in any way to otherwise limit the scope of the invention.

### Example 1

Table 2 provides a comparison of typical data for conventional water degumming of North American soy oil with ultrahigh shear degumming processes according to the process depicted in FIG. 4. The process employs 1.4:1 height to diameter ratio of a stirred mixing tank as an retention tank and does not include a chelation tank. Citric acid (600 ppm on a dry basis) was added to a crude feed oil stream at 76° C. Deionized water (2 wt. %) was added to the acid injected crude feed oil stream. The entire degumming process was operated at 76° C. with a flow rate of 160-320 kg/min feed rate in a commercial system. The resulting phosphorous content in the degummed oil is below 12 ppm. The results shown in Table 2 also demonstrate the oil saving and reduction in free fatty acid and chlorophyll in the degummed oil from the process according to FIG. 4.

TABLE 2

| | Conventional | | High Shear Acid | |
|---|---|---|---|---|
| | Water Degumming | | Degumming | |
| P in degummed oil | 50-100 (65) | ppm | <12 | ppm |
| TAG in Gum | 20-30% | | 15.0% | |
| Oil loss in degumming | 0.60-0.86% | | 0.45% | |
| Oil loss in alkaline refining | 0.15-0.3% | | — | |
| Total oil loss before bleaching | 0.75-1.16% | | 0.45% | |
| FFA from 0.3% crude oil | 0.25% | | 0.15-0.2% | |
| Chlorophyll | 400-450 | ppb | 150-200 | ppb |

### Example 2

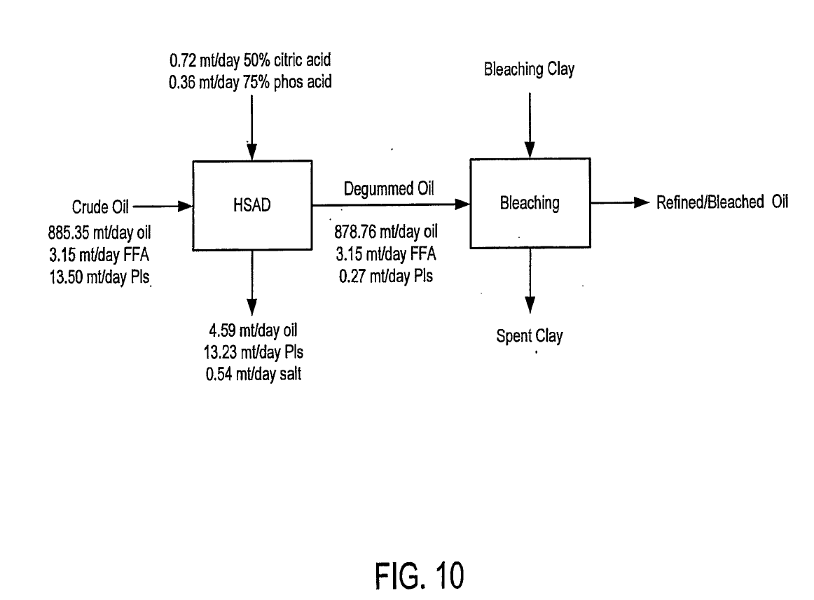

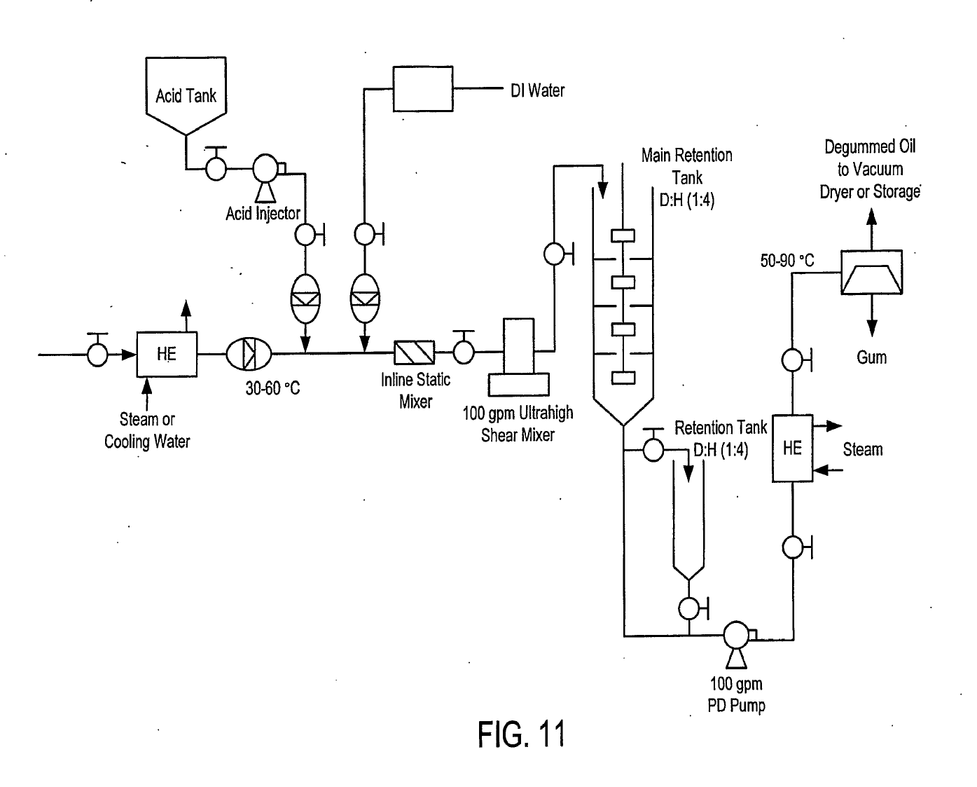

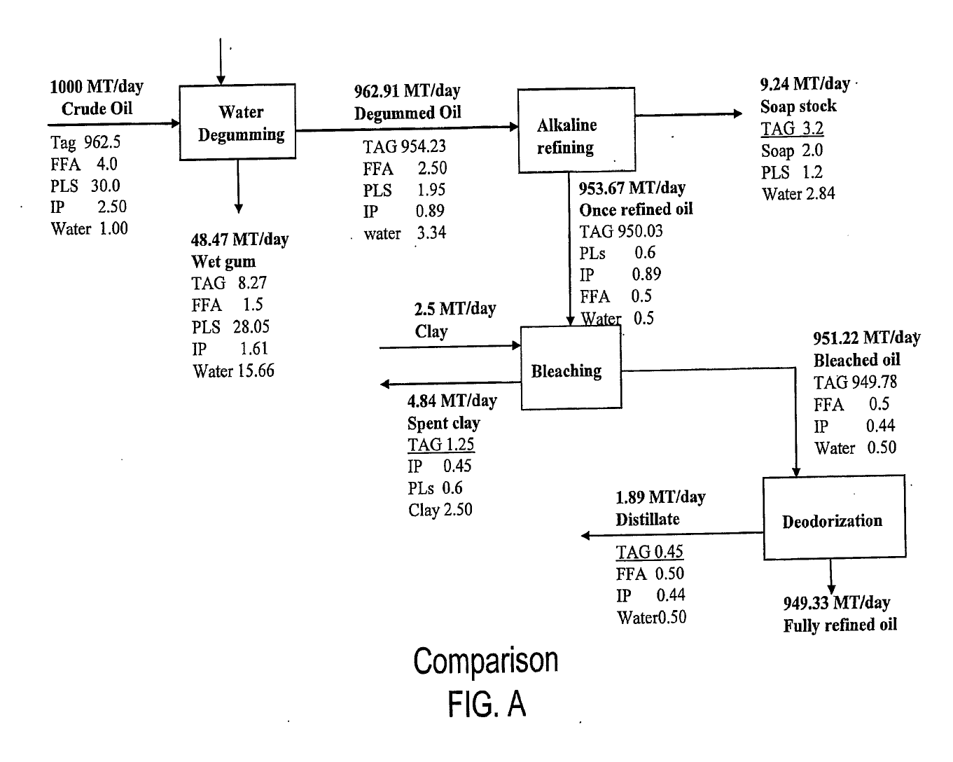

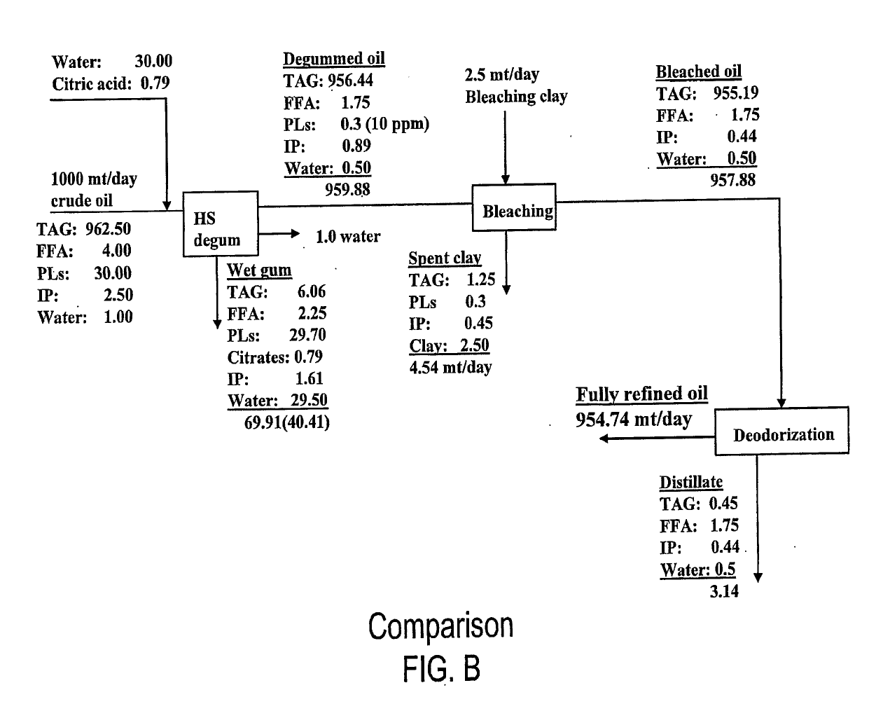

Table 3 shows the phosphorous content (measured as ppm of total phosphorous) of the degummed soy oil produced according to the process of FIG. 10 for a variety of acid and water concentrations. The citric acid and water were added prior to ultra high shear mixing in a process run in a system as illustrated in FIG. 10.

TABLE 3
Phosphorus Levels in Degummed Oil as
Function of Acid/Water Concentration

| Acid | 2% water | 2.5% water | 3% water |
|---|---|---|---|
| 970 ppm citric acid | 16.4 | 18.2 | 13.5 |
| 786 ppm citric acid | | | 12.8 |
| 600 ppm citric acid | 76.9 | 22.1 | |
| 400 ppm citric acid | 32.4 | 17.4 | |

### Example 3

Table 7 shows the effect of adding caustic (NaOH) prior to centrifugation on the composition of the degummed Canadian canola oil according to FIG. 6. The feed oil to the process chelation tank is composed of ⅔ of crude pressed canola oil and ⅓ of solvent extracted canola oil. The processing rate was 500-700 kg/min of feed crude oil in a commercial system. A mixture of 400 ppm citric and 300 ppm phosphoric acids on a dry basis was added to crude feed oil stream at 62° C. 1.8% deionized water was added to an acid chelated crude feed oil stream. Temperature of ultrahigh shear inline micro-mixing and agglomeration was set at 62° C. with 45 min residence time in the retention tank. The centrifuge temperature was set at 75° C.

Table 7 demonstrates that an acid degumming process, applying the ultrahigh shear inline micro-mixer, produces the degummed soy oil having 5.9 ppm phosphorous from the crude soy oil despite of total 230.8 ppm metal content in the crude oil. This is 98.9% and 98.9% removal of phospholipids and total metals, respectively. The impurities in the degummed oil without the caustic treatment is sufficiently low enough to proceed for effective bleaching operation followed by direct deodorization with nearly no load increase in these operations. Due to the results of the ultrahigh shear inline micro-mixing degumming process, no alkaline refining was necessary for the ultrahigh shear inline micro-mixing degumming with acids alone.

Generally, the addition of caustic to the mixed oil stream may reduce the free fatty acid content and thereby reduce the loading on down stream processes such as deodorization. Particularly, Table 6 demonstrates that the quality of a caustic treated degummed oil is within the specification (<10 ppm P and <0.1% free fatty acid) of a biodiesel feed stock. However, with the addition of caustic, the total phosphorous in the degummed oil stream generally increases somewhat and soap content in the degummed oil is higher than 30 ppm of soap. Typically 30 ppm of soap is specification for an effective bleaching operation.

TABLE 7
Effect of Added Caustic Prior to Centrifugation

| | Crude Oil | No Caustic | Caustic W/Static Mixer | |
|---|---|---|---|---|
| NaOH, ppm | — | — | 136 ppm | 250 ppm |
| P, ppm | 518.4 | 5.93 | 13.4 | 8.09 |
| FFA, % | 0.43 | 0.35 | 0.05 | 0.02 |
| Na, ppm | 0.32 | 0.32 | 7.03 | 9.39 |
| Soap, ppm | 4.3 | 4.3 | 93.5 | 124.9 |
| Calcium | 144.8 | 1.73 | 10.0 | 5.23 |
| Magnesium | 84.4 | 0.83 | 3.75 | 1.92 |
| Iron | 1.6 | 0.10 | 0.12 | 0.06 |

### Example 4

A crude soybean oil steam, e.g., of the type commonly produced via a hexane extraction process, is degummed according to the process illustrated in FIG. 1. The crude soybean oil stream typically has a phosphorus content of at least about 300 ppm and a phospholipid (“PLS”) content of at least about 10,000 ppm (i.e., circa 1.0 wt. % “PLS” or higher). Water (typically 2 to 3 wt. % based on the weight of the resulting total feed stream) is added to the crude soybean oil which is maintained at about 45-60° C. It is often desirable to add chelating acid (e.g., citric acid and/or phosphoric acid) as part of the added water stream. The “wet” feed stream is passed through an ultra high shear mixer (such as a DISPAX model ultra high shear mixer (“UHS mixer”) available from IKA) with a residence time of about 0.1 to 0.3 seconds. The flow rate through the mixer is typically about 50 to 100 gpm. The resulting mixed stream may be separated into aqueous and oil streams via centrifugation. The centrifugation is desirably carried out with the mixed stream maintained at a temperature of about 60-80° C. The degummed oil stream produced by the separation operation is commonly subjected to bleaching and deodorization operations to provide a further refined, degummed soybean oil. The phosphorus and fatty acid contents of the degummed oil stream produced by the separation operation may be such that there is no need to subject the oil stream to an alkaline refining and/or pre-deodorization operation as part of the final refining operations.

### Example 5

A crude soybean oil steam, such as the oil described in Example 4, may be degummed according to the process illustrated in FIG. 4. Water (typically 2 to 3 wt. % based on the weight of the resulting total feed stream), optionally containing chelating acid (e.g., 100-400 ppm phosphoric acid and 100-400 ppm citric acid), is added to the crude soybean oil which is maintained at about 45-60° C. The resulting “wet” feed stream is mixed with a static mixer and then passed through an IKA DISPAX model ultra high shear mixer with a residence time of about 0.1 to 0.3 seconds in the UHS mixer. The resulting mixed stream is then passed through a retention tank to provide an agglomerated stream. The retention tank typically has a height which is about 2 to 5 times its diameter and may include baffles and/or mixing devices configured to substantially inhibit or prevent backflow within the retention tank. For a system with a 50 to 100 gpm flow rate through the UHS mixer, the retention tank commonly has a volume of about 3,000-6,000 gallons. The agglomerated stream exiting the retention tank may be heated, e.g., to about 60-80° C., before being separated via centrifugation into aqueous and oil streams. The degummed oil stream produced by the separation operation is commonly subjected to bleaching and deodorization operations to provide a final refined, degummed soybean oil.

### Example 6

A crude soybean oil steam (circa 100 metric tons of crude soy bean oil per day, such as the oil described in Example 4 (e.g., containing about 96.5 wt. % triacylglycerides, 2.4 wt. % phospholipids, and 0.7 wt. % free fatty acid), may be degummed according to the process illustrated in FIG. 5. Water (about 2.5 metric tons per day), containing chelating acid (e.g., about 600 ppm citric acid on a total feed stream basis) and caustic (e.g., about 2 molar equivalent NaOH) is added to the crude soybean oil which is maintained at about 45-60° C. The resulting “wet” feed stream is mixed with an inline static mixer and then passed through an IKA DISPAX model ultra high shear mixer with a residence time of about 0.1 to 0.3 seconds in the UHS mixer. The resulting mixed stream is then passed through a retention tank to produce an agglomerated stream. The retention tank typically has a height which is about 2 to 5 times its diameter and may include baffles and/or mixing devices configured to substantially inhibit or prevent backflow within the retention tank. For a system with a 50 to 100 gpm flow rate through the UHS mixer, the main retention tank commonly has a volume of about 3,000-6,000 gallons with resulting effective residence times of about 0.5 to 2 hours. The agglomerated stream exiting the retention tank may be split into roughly two equal streams with one stream recycled to a point upstream of the ultra high shear mixer. Alternatively, the proportion of the recycled stream may be varied as desired. The other portion of the agglomerated stream may be heated, e.g., to about 60-80° C., before being separated via centrifugation into aqueous and oil streams. The resulting aqueous gum containing stream may include about 0.25 metric tons per day triacylglycerides, 2.5 metric tons per day phospholipids, 0.3 metric tons per day free fatty acid, and 2.5 metric tons per day water. The degummed oil stream may contain about 96 to 96.5 metric tons per day triacylglyceride, no more than about 300 ppm phospholipids, and no more than about 0.4 metric tons per day free fatty acids. The degummed oil stream produced by the separation operation is commonly subjected to bleaching and deodorization operations to provide a final refined, degummed soybean oil.

### Example 7

A crude soybean oil steam, such as the oil described in Example 4, may be degummed according to the process illustrated in FIG. 6. Water (typically 2 to 3 wt. % based on the weight of the resulting total feed stream), optionally containing chelating acid (e.g., 100-200 ppm phosphoric acid and 100-200 ppm citric acid) is added to the crude soybean oil which is maintained at about 45-60° C. The resulting “wet” feed stream is mixed with a static mixer and then passed through an IKA DISPAX model ultra high shear mixer with a residence time of about 0.1 to 0.3 second. The resulting mixed stream may be heated, e.g., to about 60-80° C., before being separated via centrifugation into aqueous (“wet gum”) and oil streams. The aqueous gum containing stream may then be treated by conventional enzymatic degumming, e.g., using an operation similar to that depicted in Comparison FIG. B, to provide a gum fraction and a recovered oil stream. The recovered oil stream may be recycled and added to the “wet” oil stream upstream of the ultra high shear mixer. The degummed oil stream produced by the separation operation is commonly subjected to bleaching and deodorization operations to provide a final refined, degummed soybean oil.

### Example 8

A crude soybean oil steam comprising 100 metric tons of crude soy bean oil per day, such as the oil described in Example 4 (e.g., containing about 97 wt. % triacylglycerides, 1000 ppm phospholipids, and 0.7 wt. % free fatty acid), may be may be degummed according to the process illustrated in FIG. 1. Water (about 2.5 metric tons per day), containing chelating acid (e.g., about 400 ppm phosphoric acid) and caustic (e.g., about 2 molar equivalent NaOH) is added to the crude soybean oil which is maintained at about 45-60° C. The resulting “wet” feed stream is mixed with a static mixer and then passed through an ultra high shear mixer with a residence time of about 0.1. to 0.3 seconds in the UHS mixer. The resulting mixed stream is then passed through a retention tank to produce an agglomerated stream. The retention tank typically has a height which is about 2 to 5 times its diameter and may include baffles and/or mixing devices configured to substantially inhibit or prevent backflow within the retention tank. For a system with a 50 to 100 gpm flow rate through the UHS mixer, the retention tank commonly has a volume of about 3,000-6,000 gallons. In some embodiments, the process stream exiting the main retention tank may be passed through a second retention tank, e.g., a tank having roughly 25 to 50% of the volume of the main retention tank, to further agglomerate the aqueous portion of the process stream prior to separation. The agglomerated stream exiting the retention tank may be heated, e.g., to about 60-80° C., before being separated via centrifugation into aqueous and oil streams. The aqueous gum containing stream may include about 0.25 metric tons per day triacylglycerides, 2.4 metric tons per day phospholipids, 0.3 metric tons per day free fatty acid, and 2.5 metric tons per day water. The degummed oil stream may contain about 96.7 metric tons per day triacylglyceride, 100 to 200 ppm phospholipids, and 0.4 metric tons per day free fatty acids. The degummed oil stream produced by the separation operation is commonly subjected to bleaching and deodorization operations to provide a final refined, degummed soybean oil.

### Example 9

A crude soybean oil steam comprising 900 metric tons of crude soy bean oil per day, such as the one described in Example 4 (e.g., containing about 885 metric tons per day triacylglycerides, 13-14 metric tons per day phospholipids, and 3-4 metric tons per day free fatty acid), may be may be degummed according to the process illustrated in FIG. 10. Water (about 2.5 metric tons per day), containing chelating acid (e.g., about 0.36 metric tons per day phosphoric acid and 0.72 metric tons per day citric acid) and caustic (e.g., about 2 molar equivalent NaOH) is added to the crude soybean oil which is maintained at about 45-60° C. The resulting “wet” feed stream is mixed with a static mixer and then passed through an ultra high shear mixer with a residence time of about 0.1. to 0.3 seconds. The resulting mixed stream is then passed through a retention tank to produce an agglomerated stream. The retention tank typically has a height which is about 2 to 6 times its diameter and may include baffles and/or mixing devices configured to substantially inhibit or prevent backflow within the retention tank. For a system with a 50 to 100 gpm flow rate through the UHS mixer, the retention tank commonly has a volume of about 3,000-6,000 gallons. The agglomerated stream exiting the primary retention tank is then passed through a second retention tank. The second retention tank typically has a height which is about 2 to 5 times its diameter and may include baffles and/or mixing devices configured to substantially inhibit or prevent backflow within the retention tank. For a system with a 50 to 100 gpm flow rate through the UHS mixer, the second retention tank suitably has a volume of about 1,000-2,000 gallons.

The agglomerated stream exiting the retention tank may be heated, e.g., to about 60-80° C., before being separated via centrifugation into aqueous and oil streams. The aqueous gum containing stream may include about 4.6 metric tons per day triacylglycerides, 13.2 metric tons per day phospholipids, 0.5 metric tons per day free fatty acid, and 2.5 metric tons per day water. The degummed oil stream may contain about 879 metric tons per day triacylglyceride, no more than about 0.3 metric tons per day phospholipids, and no more than about 3.5 metric tons per day free fatty acids. The degummed oil stream produced by the separation operation, which can have an AI of 75 or higher, may be subjected to bleaching to provide a final refined, degummed soybean oil including 875-877 metric tons per day triacylglycerides, 3-3.25 metric tons per day free fatty acid, and no more than about 300 ppm phospholipids.

### Example 10

Table 4 provides a comparison of data for North American soybean oil degummed using a conventional water degumming process and applying the ultrahigh shear degumming process according to FIG. 3. The UHS process was conducted without the addition of acids or a chelation step. The processing rate was about 5 kg/min of crude oil feed in a semi-pilot unit. Deionized water (2 wt. %) was added to a crude feed oil stream at 55° C. The temperature of ultrahigh shear mixing and subsequent hydration in the retention tank was set at 55° C. with 30 min residence time in the retention tank. The centrifuge temperature was set at 85° C.

Table 4 demonstrates that a water degumming process, applying the ultrahigh shear inline micro-mixer, produces the degummed soy oil having 11.7 ppm phosphorous from the crude soy oil despite of total 142.6 ppm metal content in the crude oil. This is 98.6% and 94.5% removal of phospholipids and total metals, respectively. In comparison to 150 ppm phosphorous in a conventional water degummed oil, it is 20.3% yield improvement in phospholipids (lecithin) recovery.

TABLE 4
Results of UHS Degumming

| | | Ultrahigh Shear Water |
|---|---|---|
| | North American | Degummed |
| | Crude Soy Oil | North American Soy Oil |
| P, ppm | 833.0 | 11.7 |
| FFA, % | 0.43 | 0.35 |
| Na, ppm | 0.3 | <0.3 |
| Calcium | 68.9 | 6.0 |
| Magnesium | 72.6 | 2.2 |
| Iron | 1.13 | 0.07 |

### Example 11

Table 5 provides acid degummed oil data for North American soy oil applying the ultrahigh shear inline micro-mixing degumming process according to FIG. 3. The processing rate was 5 kg/min of feed crude oil in a semi-pilot scale unit. A mixture of 200 ppm citric and 100 ppm phosphoric acids on a dry basis was added to a crude feed oil stream at 55° C. 2% deionized water is added to an acids-blended crude feed oil stream. Temperature of ultrahigh shear inline micro-mixing and agglomeration was set at 55° C. with 30 min residence time in the retention tank. The centrifuge temperature was set at 85° C.

Table 5 demonstrates that an acid degumming process, applying the ultrahigh shear inline micro-mixer, produces the degummed soy oil having 4.2 ppm phosphorous from the crude soy oil despite of total 136.31 ppm metal content in the crude oil. This is 99.5% and 99.4% removal of phospholipids and total metals, respectively. Due to the results of the ultrahigh shear inline micro-mixing degumming process, no alkaline refining was necessary. In comparison to 150 ppm phosphorous in a conventional water degummed oil, it is 20.0% yield improvement in phospholipids (lecithin) recovery.

TABLE 5
Results of UHS Degumming

| | | Ultrahigh Shear Acid |
|---|---|---|
| | North American | Degummed |
| | Crude Soy Oil | North American Soy Oil |
| P, ppm | 880.5 | 4.2 |
| FFA, % | 0.43 | 0.25 |
| Na, ppm | <0.3 | <0.3 |
| Calcium | 63.6 | 0.4 |
| Magnesium | 71.9 | 0.3 |
| Iron | 0.81 | <0.06 |

### Example 12

Table 5 provides acid degummed oil data for Canadian canola oil applying the ultrahigh shear inline micro-mixing degumming process according to FIG. 6. The feed oil to the process chelation tank is composed of ⅔ of crude pressed canola oil and ⅓ of solvent extracted canola oil. The processing rate was 500-700 kg/min of feed crude oil in a commercial system. A mixture of 200 ppm citric and 150 ppm phosphoric acids on a dry basis was added to a crude feed oil stream at 58° C. 1.8% deionized water was added to an acid chelated crude feed oil stream. Temperature of ultrahigh shear inline micro-mixing and agglomeration was set at 58° C. with 45 min residence time in the retention tank. The centrifuge temperature was set at 85° C.

Table 6 demonstrates that an acid degumming process, employing an ultrahigh shear inline micro-mixer can produce a degummed canola oil having 4.2 ppm phosphorous from the crude canola oil despite having a 231 ppm total metal content and 518 ppm phosphorus content in the crude oil. This constitutes is 99.2% and 99.1% removal of phospholipids and total metals, respectively. Due to the excellent results of the ultrahigh shear inline micro-mixing degumming process, no alkaline refining was necessary. The AI in the separated wet gum stream is about 80 (dry basis) when the process is run under conditions of; 2.0% water; addition of acid mixture of 200 ppm citric and 300 ppm phosphoric acids; chelation and ultrahigh shear inline micro-mixing and agglomeration at 58° C. and centrifuge temperature at 90° C.

TABLE 6
Results of UHS Degumming

| | Canadian Crude | Ultrahigh Shear Acid |
|---|---|---|
| | Canola Oil | Degummed Canola Oil |
| P, ppm | 518.4 | 4.15 |
| FFA, % | 0.43 | 0.35 |
| Na, ppm | 0.32 | <0.3 |
| Calcium | 144.8 | 1.18 |
| Magnesium | 84.4 | 0.95 |
| Iron | 1.6 | 0.05 |

### Exemplary Embodiments

Some embodiments relate to a method of degumming a plant derived oil comprising: mixing a feed stream under ultrahigh shear conditions to provide a mixed stream; wherein the feed stream comprises water and a plant-based oil having a phospholipid content; and separating the mixed stream into a wet gum stream and an oil stream; wherein the oil stream has a phospholipid content, which is no more than about 3% and, more desirably no more than about 2% of the phospholipid content of the feed stream, and comply no more than about 0.5 wt. % free fatty acids. The phospholipid content of the oil stream is commonly no more than about 500 ppm and more desirably no more than about 300 ppm. In some embodiments, the feed stream may further also include chelating acid and/or a salt thereof. The mixed stream may have an aqueous component with a pH of about 4 to 6.5. The feed stream may also comprise about 1 to 6 wt. % water. The feed stream may comprise at least about 25 ppm phosphorus. In some of these embodiments, the feed stream may include about 10,000 ppm or even higher amounts of phospholipids. Such feed streams commonly have a total phosphorus content of at least about 300 ppm.

The method may also comprise passing the mixed stream through a retention tank prior to the separating operation. In some of these embodiments, the mixed stream may have an effective residence time in the retention tank of at least about 5 minutes. Alternatively, the effective residence time in the retention tank may be 30 to 100 minutes.

In some embodiments, the mixing operation may comprise subjecting the feed stream to ultrahigh shear conditions having a shear frequency of at least about 100,000 sec⁻¹ and, more typically, at least about 1,000,000 sec¹. In some embodiments, the mixing operation may comprise subjecting the feed stream to ultrahigh shear conditions having a shear rate of at least about 5,000 sec⁻¹ and, commonly, about 10,000 sec⁻¹ or higher. Also, the mixing operation may comprise subjecting the feed stream to ultrahigh shear conditions having a shear number of about 100,000,000 sec⁻² or higher and, commonly, at least about 10⁹ sec⁻² or higher. In some embodiments, the feed stream may be under ultrahigh shear conditions for no more than about 0.5 minute. The feed stream may have a temperature of about 30° C. to 90° C. with feed stream temperatures of about 40° C. to 80° C. being quite common. In some embodiments, the separating operation may be carried out at a temperature of about 60° C. to 95° C.

In some embodiments, the oil phase may include at least about 99 wt % triacylglycerol. The oil stream may have a chlorophyll content which is no more than about 50 wt % of the feed stream chlorophyll content. In some embodiments, the oil stream may have a phospholipid content of no more than about 300 ppm. The oil stream may have a total phosphorous content of no more than about 10 ppm, and in some embodiments, no more than about 5 ppm. In some embodiments, the oil stream may have a phospholipid content of no more than about 100 ppm. The oil stream may have a combined total content of Ca++, Mg++ and/or Fe+++ metal ions of no more than about 10 ppm. The wet gum stream produced by the present method commonly has of phospholipids content of about 70 to 82 AI, with wet gum streams having an AI of at least abut 75 being quite common.

Some embodiments relate to a method of degumming a plant derived oil comprising: mixing a feed stream under ultrahigh shear conditions to provide a mixed stream, wherein the feed stream comprises a plant derived oil; water; phospholipids; and has a phospholipase enzyme activity of no more than about the activity equivalent to about 5 ppm phospholipase enzyme; and separating the mixed stream to provide an aqueous stream and an oil stream.

In some embodiments, the feed stream further may comprise a chelating carboxylic acid and/or salt thereof. The chelating acid may comprise alpha-hydroxy carboxylic acid. In some embodiments, the chelating acid may comprise phosphoric acid, citric acid or a mixture thereof. The feed stream may comprise at least about 100 ppm of the chelating acid and/or salt thereof. The feed stream may comprise no more than about 1,000 ppm of the chelating acid and/or salt thereof. In some embodiments, the feed stream may comprise about 100 ppm to 600 ppm of the chelating acid and/or salt thereof.

In some embodiments, the feed stream may comprise an organic acid. The organic acid may be citric acid, lactic acid, gluconic acid, glycolic acid, propionic acid, acetic acid, oxalic acid, tartaric acid or a mixture thereof. The organic acid may comprise alpha-hydroxy carboxylic acid.

Yet other embodiments relate to a method of degumming a plant derived oil comprising: mixing a feed stream comprising water and a plant derived oil having a phospholipid content under ultrahigh shear conditions to provide a mixed stream; and separating the mixed into an aqueous stream and an oil stream.

In some of these embodiments, the method may comprise adding acid to the feed stream prior to the mixing operation. The separating operation may comprise using a centrifuge. In some embodiments, the retaining operation may include agitating the mixed stream in the retention tank under low shear conditions, e.g. under conditions having a shear number of no more than about 1,000 sec⁻² and, more commonly under conditions having a shear number of no more than about 500 sec⁻² Optionally, the method may further comprise bleaching the oil stream.

The method may optionally comprise deodorizing the oil stream.

In some embodiments, the method may not include a predeodorization operation. In some embodiments, the method of may not include an alkaline refining operation.

Some embodiments relate to a method of degumming a plant derived oil comprising: adding water to a plant derived oil stream; adding a chelating acid and/or a salt thereof to the plant derived oil stream; mixing the water, the chelating acid and/or salt thereof, and the plant derived oil under ultrahigh shear conditions to provide a mixed stream; and separating the mixed stream to provide an oil stream and an aqueous stream.

The water and the chelating acid and/or salt thereof may be added as separate input streams, or, alternatively, the chelating acid and/or salt thereof is added to the plant derived oil stream as an aqueous stream.

The method may further comprise adding an acid neutralizing agent to the mixed oil stream prior to the separating operation. In some embodiments, the acid neutralizing agent comprises sodium hydroxide, potassium hydroxide or a mixture thereof.

Some embodiments relate to a system for degumming a plant-derived oil comprising: an oil feed stream line in fluid connection with an ultrahigh shear mixer; a retention tank in fluid connection with the ultrahigh shear mixer; and an oil/aqueous phase separation device in fluid connection with the retention tank.

The oil/aqueous phase separation device may comprise an oil stream output line and an aqueous stream output line; and the system further comprises a deodorization unit and/or bleaching unit in fluid connection with the oil stream output line.

The system may further comprise a mixed stream recycle line in fluid connection with the retention tank and the oil feed stream line.

Optionally, the system may further comprise an enzymatic treatment unit in fluid connection with the aqueous stream output line to aid in recovering oil from the aqueous gum phase. In some embodiments, the system may further comprise at least one input line in fluid connection with the oil feed stream line.

In some embodiments, the system may not include an alkaline refining unit, a predeodorization unit, or both.

In some embodiments, the retention tank may have a height that is at least about three times its diameter. The system may further comprise a second retention tank in fluid connection in series between the retention tank and the oil/aqueous phase separation device. In some embodiments, the retention tank may have a volume which is at least 25 times the volume of the second retention tank. In some of these embodiments, the retention tank may have a volume of at least about 50 times the volume of the second retention tank. More commonly, the volume of the main retention tank is about 2 to 5 times the volume of the secondary retention tank.

The system may further comprising a heater disposed between the retention tank and the separation device.

Some embodiments relate to a method of degumming a plant derived oil comprising: mixing a feed stream under ultrahigh shear conditions to provide a mixed stream, wherein the feed stream comprises water and a plant derived oil including a phospholipid component; and separating the mixed stream into an aqueous stream and an oil stream; wherein the oil stream includes no more than about 500 ppm phospholipids and no more than about 1.0 wt % free fatty acids.

The oil stream may include no more than about 300 ppm phospholipids. In some of these embodiments, the oil stream may comprise no more than about 200 ppm phospholipids.

The AI (“acetone insoluble”) of a wet gum stream is a rough indication of phospholipids fraction in the gum (dry basis). 1-AI is a fraction representing oil (TAG, DAG, MAG and other minor oil component) and free fatty acid. Oil loss can be reported as (dry gum)×(1/AI−1). From processing of 1000 ppm P crude oil, the dry gum will be approximately 3% of crude oil. Oil loss for 65 AI is 1.61% of crude oil. Oil loss for 75, 80 and 82 AI is 1.00%, 0.75% and 0.66% of crude oil, respectively. If desired, the wet gum stream may be subjected to further processing (e.g., dewatering and dewatering/deoiling) of a wet gum into dry gum or fluid lecithin or powdered lecithin. Dewatering process produces dry gum or fluid lecithin. Deoiling of fluid lecithin produces powdered lecithin.

Yet other embodiments relate to a method of degumming a plant derived oil comprising: mixing a feed stream under ultrahigh shear conditions to provide a mixed stream, wherein the feed stream comprises water and a plant derived oil including a phospholipid component; and separating the mixed stream into an aqueous stream and an oil stream; wherein the oil stream includes no more than about 20 ppm and more desirably, no more than about 15 ppm phosphorus and no more than about 1.0 wt. % free fatty acids.

Some embodiments relate to a method of degumming a plant derived oil comprising: adding chelating acid and/or a salt thereof and water to a plant derived oil to provide a feed stream; wherein the plant derived oil stream has a phospholipid content of at least about 1,000 ppm; mixing the feed stream under ultrahigh shear conditions to provide a mixed stream having an aqueous component with a pH of about 3 to 7; passing the mixed stream through a retention tank to provide a second mixed stream; and separating the agglomerated mixed stream to provide an oil stream and an aqueous stream; wherein the oil stream includes no more than about 25 ppm phospholipids and no more than about 0.3 wt. % free fatty acids.

The oil stream may have a calcium content of no more than about 5 ppm.

The oil stream may have a magnesium content of no more than about 5 ppm.

Some embodiments relate to a method of degumming a plant derived oil comprising mixing a feed stream under ultrahigh shear conditions to provide a mixed stream. separating the mixed stream to provide an aqueous stream and an oil stream. The feed stream comprises a plant derived oil; water; phospholipids; and has substantially no phospholipase enzyme activity (e.g., equivalent to no more than about 5 ppm phospholipase enzyme). The feed stream may further comprises a chelating acid and/or salt thereof. The chelating acid may comprise an alpha-hydroxy carboxylic acid. In some embodiments, the chelating acid comprises phosphoric acid, citric acid or a mixture thereof.

The feed stream may comprise at least about 100 ppm of the chelating acid and/or salt thereof. In other embodiments, the feed stream may comprise no more than about 1,000 ppm of the chelating acid and/or salt thereof. Commonly, the feed stream may comprise about 100-600 ppm of the chelating acid and/or salt thereof.

In some of these embodiments, the feed stream further comprises an organic acid. The organic acid may comprise citric acid, lactic acid, gluconic acid, glycolic acid, propionic acid, acetic acid or a mixture thereof. Commonly, the organic acid comprises alpha-hydroxy carboxylic acid, e.g., citric acid, lactic acid, gluconic acid, glycolic acid or a mixture thereof.

Other embodiments relate to a method of degumming a plant derived oil comprising mixing a feed stream comprising water and a plant derived oil having a phospholipid content under ultrahigh shear conditions to provide a mixed stream and separating the mixed into an aqueous stream and an oil stream. The method may further comprise adding acid to the feed stream prior to the mixing operation. Some of these methods may not include a predeodorization operation, an alkaline refining operation, or both.

It will be readily apparent to one skilled in the art that varying substitutions and modifications may be made to the invention disclosed herein without departing from the scope and spirit of the invention. The invention illustratively described herein suitably may be practiced in the absence of any element or elements, limitation or limitations which is not specifically disclosed herein. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention. Thus, it should be understood that although the present invention has been illustrated by specific embodiments and optional features, modification and/or variation of the concepts herein disclosed may be resorted to by those skilled in the art, and that such modifications and variations are considered to be within the scope of this invention.

In addition, where features or aspects of the invention are described in terms of Markush groups or other grouping of alternatives, those skilled in the art will recognize that the invention is also thereby described in terms of any individual member or subgroup of members of the Markush group or other group.

Also, unless indicated to the contrary, where various numerical values are provided for embodiments, additional embodiments are described by taking any 2 different values as the endpoints of a range. Such ranges are also within the scope of the described invention.

What is claimed is:

1. A method of degumming a triglyceride oil comprising:
mixing a feed stream under ultrahigh shear conditions to provide a mixed stream; wherein the feed stream comprises water and a triglyceride oil having a total phosphorous content of at least 200 ppm;
passing the mixed stream through a retention tank; and
separating the mixed stream into an oil stream and a wet gum stream;
such that the oil stream has a phosphorous content of no more than about 20 ppm; and a free fatty acid content which is less than the free fatty acid content of the feed stream.

2. The method of claim 1, wherein the feed stream comprises about 1.0 to 5.0 wt. % water. {pref. 1.5-3.0 wt. %}.

3. The method of claim 1, wherein the feed stream further comprises a chelating carboxylic acid and/or a salt thereof.

4. The method of claim 3, wherein the feed stream comprises at least about 100 ppm of the chelating carboxylic acid and/or salt thereof.

5. The method of claim 3, wherein the feed stream further comprises phosphoric acid and/or salt thereof.

6. The method of claim 1, further comprising adding phosphoric acid and citric acid in a weight ratio of about 1:3 to 3:1 to the feed stream prior to the mixing operation.

7. The method of claim 6, wherein the feed stream comprises about 100 to 400 ppm phosphoric acid and about 100 to 800 ppm citric acid.

8. The method of claim 6, further comprising mixing the acidified feed stream in a chelation tank prior to the ultrahigh shear mixing operation. {e.g., for about 10 to 60 minutes}.

9. The method of claim 6, further comprising mixing the acidified feed stream with an inline static mixer prior to the ultrahigh shear mixing operation.

10. The method of claim 1, wherein the mixed stream has an aqueous component with a pH of about 4 to 6.5.

11. The method of claim 1, wherein the feed stream comprises at least about 10,000 ppm phospholipids.

12. The method of claim 1, wherein the mixed stream has an effective residence time in the retention tank of at least about 5 minutes (typically at least about 30 minutes).

13. The method of claim 1, wherein the feed stream is substantially free of phospholipase enzyme activity.

14. The method of claim 1, wherein the mixing operation comprises subjecting the feed stream to ultrahigh shear conditions having a shear frequency of at least about 100,000 sec⁻¹.

15. The method of claim 1, wherein the mixing operation comprises subjecting the feed stream to ultrahigh shear conditions having a shear rate of at least about 5,000 sec⁻¹.

16. The method of claim 1, wherein the mixing operation comprises subjecting the feed stream to ultrahigh shear conditions having a shear number of at least about 100,000,000 sec⁻².

17. The method of claim 1, wherein the mixing operation is carried out with the feed stream at a temperature of about 40° C. to 90° C.

18. The method of claim 1, wherein the mixing operation is carried out by passing the feed stream through an ultrahigh shear mixer with a residence time of no more than about 0.5 second.

19. The method of claim 1, wherein the oil stream has a phospholipid content of no more than about 300 ppm.

20. The method of claim 1, wherein the oil stream has a total phosphorous content of no more than about 10 ppm.

21. The method of claim 1, wherein the separating operation is carried out with the mixed stream at about 60° C. to 95° C.

22. The method of claim 1, further comprising mixing the feed stream with an inline static mixer prior to the ultrahigh shear mixing operation.

23. The method of claim 1, wherein the oil stream has a total metal content of no more than about 10 ppm.

24. A system for degumming a triglyceride oil comprising:
an oil feed stream line in fluid connection with an inline ultrahigh shear mixer;
a retention tank in downstream fluid connection with the ultrahigh shear mixer; and
an oil/aqueous phase separation device in downstream fluid connection with the retention tank.

25. The system of claim 24, wherein said system does not include an alkaline refining unit.

26. The system of claim 24, wherein oil feed stream line comprises an inline static mixer.

27. The system of claim 24, further comprising a chelation tank in upstream fluid connection with the ultrahigh shear mixer.

28. The system of claim 24, wherein the ultrahigh shear mixer is an inline ultrahigh shear mixer.

29. A method of degumming a triglyceride comprising: adding chelating acid and/or a salt thereof and water to a plant derived oil to provide a feed stream; wherein the triglyceride has a total phosphorus content of at least about 200 ppm {more commonly at least about 500 ppm}; mixing the feed stream under ultrahigh shear conditions to provide a mixed stream having an aqueous component with a pH of about 4 to 6.5; passing the mixed stream through a retention tank to provide an agglomerated stream; and separating the agglomerated stream to provide an oil stream and an aqueous stream; wherein the oil stream has a total phosphorus content of no more than about 20 ppm; and a free fatty acid content which is less than the free fatty acid content of the feed stream.

30. The method of claim 29, wherein the feed stream comprises phosphoric acid and citric acid and/or salts thereof in a phosphoric:citric mass ratio of about 1:3 to 3:1 (on a free acid basis).

31. The method of claim 29, wherein the feed stream is at about 40° C. to 80° C. when mixed under the ultrahigh shear conditions.

32. The method of claim 29, wherein the feed stream comprises about 1.0 to 5.0 wt. % water.

33. A method of degumming a plant-based oil comprising: mixing a feed stream at about 40° C. to 80° C. under ultrahigh shear conditions to provide a mixed stream; wherein the feed stream comprises about 1 to 5 wt. % water and a plant-based oil having a first phospholipid content; and the mixed stream has a dispersed aqueous phase with a pH of about 4 to 6.5; separating the mixed stream into an oil stream and a wet gum stream; wherein the oil stream includes no more than about 0.5 wt. % free fatty acids and has a second phospholipid content, which is no more than about 3% {and more desirably, no more than about 2%} of the first phospholipid content.

34. The method of claim 33, wherein the plant-based oil is a soybean oil having a total phosphorous content of at least 300 ppm.

35. The method of claim 33, wherein the oil stream includes no more than about 0.3 wt. % free fatty acids and has a total phosphorous content of no more than about 10 ppm.

36. The method of claim 35, wherein the feed stream further comprises phosphoric acid and citric acid.

37. A method of degumming a triglyceride oil comprising: mixing a feed stream under ultrahigh shear conditions to provide a mixed stream; wherein the feed stream comprises water and a triglyceride oil having a total phosphorous content of at least about 500 ppm; passing the mixed stream through a retention tank; and separating the mixed stream into an oil stream and a wet gum stream; such that the oil stream has a second phosphorous content, which is no more than about 3% of the total phosphorous content of the feed stream, and includes no more than about 0.5 wt. % free fatty acids.

38. The method of claim 37, wherein the wet gum stream has an AI of at least about 75.

39. The method of claim 37, wherein the feed stream further comprises chelating acid and/or a salt thereof.

40. The method of claim 37, further comprising mixing the feed stream in a chelation tank prior to the ultrahigh shear mixing operation.

41. The method of claim 37, further comprising mixing the feed stream with an inline static mixer prior to the ultrahigh shear mixing operation.

42. The method of claim 1, wherein the second phosphorous content is no more than about 10 ppm.

43. The method of claim 1, wherein the oil stream includes no more than about 0.5 wt. % free fatty acids.
